(19) United States
(12) Patent Application Publication
(10) Pub. No.: US 2015/0373825 A1
(43) Pub. Date: Dec. 24, 2015

(54) TORCH FOR A ROTATING SOURCE OF PLASMA EXCITATION

(71) Applicant: Maksymilian Pluta Institute of Applied Optics, Warszawa (PL)

(72) Inventors: Krzysztof JANKOWSKI, Warszawa (PL); Slawomir PIOTROWSKI, Warszawa (PL); Andrzej RAMSZA, Warszawa (PL); Edward RESZKE, Wroclaw (PL); Anna TYBURSKA-STANIEWSKA, Ciechanow (PL)

(21) Appl. No.: 14/744,129

(22) Filed: Jun. 19, 2015

(30) Foreign Application Priority Data
Jun. 19, 2014 (PL) 408615

(51) Int. Cl. H05H 1/34

(52) U.S. Cl. CPC H05H 1/34

(57) ABSTRACT

A torch consists of an inner tube (1), a coaxially positioned outer tube (2), and at least three electrodes (3), whose tips are evenly spaced around the torch axis inside the outer tube (2). At the end of outer tube (2) there are evenly spaced electrode ports (3), extending in parallel to the torch axis from the outer tube end edge (2). In addition, the torch comprises a cylindrical head (4) sized to fit the outer diameter of the outer tube (2) provided with the same number of electrode ports (3). In another embodiment, the torch is provided with at least six electrodes (3) spaced in two planes perpendicular to the torch axis, while the head (4) has the same number of ports, wherein the difference in depth of every second port corresponds to the distance between the planes.

### CROSS REFERENCE TO RELATED APPLICATIONS

This application claims priority under 35 U.S.C. §119 to Polish Application No. PL408615, filed on Jun. 19, 2014, the contents of which are hereby incorporated by reference herein.

### FIELD OF THE INVENTION

The subject of the invention is a torch for a rotating source of plasma excitation intended for use in optical emission spectrometry and mass spectrometry to obtain microwave-induced plasma or pulsed high voltage plasma.

### SUMMARY

In a rotating source of plasma excitation, two types of plasma, microwave-induced plasma and pulsed high voltage plasma, are generated between electrode tips positioned symmetrically on a torch wheel perimeter. The torch comprises two coaxially positioned tubes. Aerosol or working gas mixture with an analytic sample flows through the inner tube, while pure working gas flows through the ring between the inner and outer tube. One of inert gases can be used as a working gas, e.g. helium or argon or a molecular gas, like nitrogen or air. The tubes are made of heat-resistant dielectric material, e.g. of quartz or Al₂O₃ ceramic. In this type of double-stream torches the end of the inner tube must be positioned below electrode tips, i.e. below plasma generated in the torch, while the outer tube ends over the electrode tips, therefore the electrodes must run through the openings located on its perimeter. Because of the requirement to maintain tightness in the plasma excitation area, the openings must be accurately sized to fit the electrode diameter.

A torch for the rotating source of plasma excitation, composed of an inner tube, a coaxially positioned outer tube, and at least three electrodes, whose tips are evenly distributed around the torch axis inside the outer tube, according to the invention characterized by locating at the end of the outer tube evenly spaced ports for electrodes, running parallel to the torch axis from the outer tube end edge. In addition, the torch comprises a cylindrical head sized to fit the outer diameter of the outer tube provided with the same number of electrode ports. Preferably, the ports in the outer tube and the cylindrical head have a rounded base with a curvature radius corresponding to the electrode diameter, the width of ports corresponds to the diameter of electrodes, and the head is seated to slide in the outer tube.

Another torch for the rotating source of plasma excitation, composed of an inner tube, a coaxially positioned outer tube, and at least six electrodes, whose tips are evenly spaced around the torch axis inside the outer tube, according to the invention characterized in that the electrodes are spaced in two planes perpendicular to the torch axis in such a way that every second electrode is equally spaced from the outer tube end edge, while at the end of the outer tube there are evenly distributed ports for electrodes, running parallel to the torch axis from the outer tube end edge. In addition, the torch comprises a cylindrical head sized to fit the outer diameter of the outer tube provided with the same number of electrode ports, wherein the difference in depth of every second outer tube port and the cylindrical head corresponds to the distance between electrode position planes. Preferably, the ports in the outer tube and the cylindrical head have a rounded base with a curvature radius corresponding to the electrode diameter, the width of ports corresponds to the diameter of electrodes, and the head is seated to slide in the outer tube.

The solution according to the invention makes it possible to install and remove electrodes, provides sufficient outer tube tightness in the place of electrode passage, and facilitates torch maintenance.

### BRIEF DESCRIPTION OF THE DRAWINGS

The invention is explained in an embodiment example shown in a drawing, where:

FIG. 1 presents a torch for a rotating source of plasma excitation in axial cross-section, while

FIG. 2 presents a second embodiment of a torch for a rotating source of plasma excitation in axial cross-section.

### DETAILED DESCRIPTION OF THE PREFERRED EMBODIMENTS

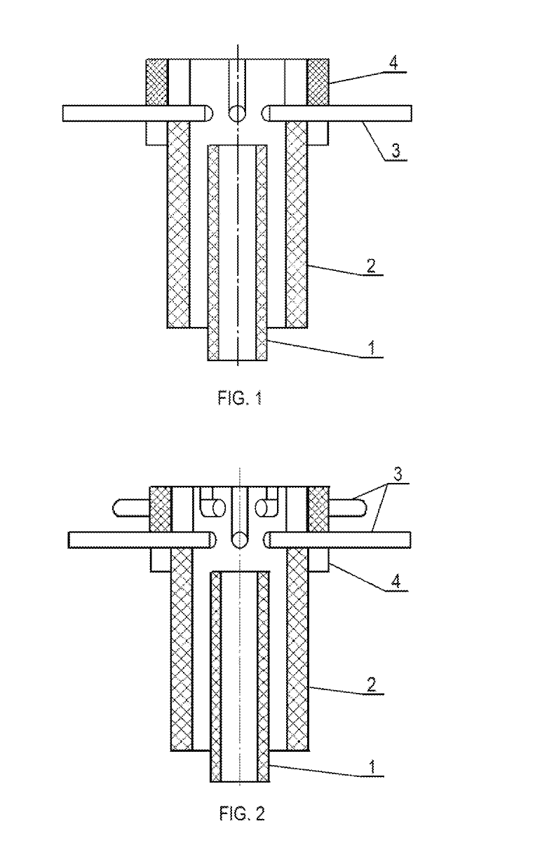

The torch presented in FIG. 1 consists of an inner tube 1, a coaxially positioned outer tube 2 and four electrodes 3 evenly spaced around the torch axis. The electrode tips 3 are located inside the outer tube 2. At the end of the outer tube 2 there are evenly spaced electrode ports 3. The ports run parallel to the torch axis from the outer tube end edge 2. The torch comprises a cylindrical head 4 sized to fit the outer diameter of the outer tube 2 and seated to slide in the outer tube 2. The head 4 is provided with the same number of electrode ports 3 as the outer tube 2. The width of ports corresponds to the diameter of electrodes 3. The ports provided in the outer tube 2 and cylindrical head 4 have a rounded base with a curvature radius corresponding to the diameter of electrodes 3. This torch is intended for the rotating source of plasma excitation, where the tips of electrodes 3 are spaced in a single plane perpendicular to the torch axis. For three electrodes 3 their tips will be spaced every 120 degrees. The same configuration will have the electrode ports 3 in the outer tube 2 and head 4.

The torch presented in FIG. 2 is provided with an inner tube 1, coaxially positioned outer tube 2 and eight electrodes 3. The tips of electrodes 3 are evenly spaced around the torch axis inside the inner tube 2 in two planes perpendicular to the torch axis. Every second electrode 3 is evenly spaced from the outer tube end edge 2. At the end of outer tube 2 there are evenly spaced electrode ports 3, running in parallel to the torch axis from the outer tube end edge 2. The torch comprises a cylindrical head 4 sized to fit the outer diameter of the outer tube 2 provided with the same number of electrode ports as the outer tube. The difference in depth of every second outer tube 2 port and the cylindrical head 4 corresponds to the distance between electrode 3 position planes.

The head 4 is seated to slide in the outer tube 2. The ports provided in the outer tube 2 and cylindrical head 4 have a rounded base with a curvature radius corresponding to the diameter of electrodes 3.

The torch presented in FIG. 2 is intended for the rotating source of plasma excitation provided with at least six electrodes 3 evenly spaced in two planes perpendicular to the torch axis. For six electrodes 3 spaced like this, the tip of every second electrode 3 will be placed by maintaining the same distance from the outer tube 2 edge, wherein the electrode tips 3 in each plane will be spaced every 120 degrees. The same configuration will have the electrode ports 3 in the outer tube 2 and head 4.

1. A torch for a rotating source of plasma excitation, comprising an inner tube, a coaxially positioned outer tube, and at least three electrodes, whose tips are evenly distributed around the torch axis inside the outer tube, wherein located at an end of the outer tube are (2) evenly spaced electrode ports (3), extending parallel to the torch axis from the outer tube end edge (2), and wherein the torch further comprises a cylindrical head (4) sized to fit the outer diameter of the outer tube (2) and provided with the same number of electrode ports (3).

2. The torch of claim 1, wherein the ports provided in the outer tube (2) and cylindrical head (4) have a rounded base with a curvature radius corresponding to the diameter of electrodes (3), the width of ports corresponds to the diameter of electrodes (3), and the head (4) is seated to slide in the outer tube (2).

3. A torch for a rotating source of plasma excitation, comprising an inner tube, a coaxially positioned outer tube, and at least six electrodes, whose tips are evenly spaced around the torch axis inside the outer tube, wherein the electrodes (3) are spaced in two planes perpendicular to the torch axis in such a way that every second electrode (3) is equally spaced from the outer tube end edge (2), while at the end of the outer tube (2) there are evenly distributed ports for electrodes, extending parallel to the torch axis from the outer tube end edge (2) and wherein the torch further comprises a cylindrical head (4) sized to fit the outer diameter of the outer tube (2) provided with the same number of electrode ports (3), wherein the difference in depth of every second outer tube port (2) and the cylindrical head (4) corresponds to the distance between planes.

4. The torch of claim 3, wherein the ports provided in the outer tube (2) and cylindrical head (4) have a rounded base with a curvature radius corresponding to the diameter of electrodes (3), the width of ports corresponds to the diameter of electrodes (3), and the head (4) is seated to slide in the outer tube (2).
